(19) United States
(12) Patent Application Publication
(10) Pub. No.: US 2026/0307514 A1
(43) Pub. Date: Oct. 8, 2026

(54) SYSTEMS AND METHODS FOR SMART VEHICLE ACCESS FOR VEHICLES WITH A DEAD BATTERY

(71) Applicant: GM GLOBAL TECHNOLOGY OPERATIONS LLC, Detroit, MI (US)

(72) Inventors: Azin NEISHABOORI, Plymouth, MI (US); Ahmed F. AL ALAWY, Canton, MI (US); Venkata Naga Siva Vikas VEMURI, Farmington Hills, MI (US)

(21) Appl. No.: 19/169,142

(22) Filed: Apr. 3, 2025

(51) Int. Cl. B60L 53/126; B60L 53/62; B60L 53/65; B60L 53/66; H01M 10/44; H01M 10/46; H02J 50/00; H02J 50/20

(52) U.S. Cl. CPC B60L 53/126; B60L 53/62; B60L 53/65; B60L 53/66; H01M 10/44; H01M 10/46; H02J 50/001; H02J 50/20

(57) ABSTRACT

A system includes vehicles each including a local control module, a radio frequency (RF) communication module, an energy harvesting module, and a battery module, and a system control module in communication with the local control module of each vehicle. The system control module is configured to acquire a vehicle energy status from the local control module of each vehicle, the vehicle energy status including a power donor status, a power conserving status, or a depleted battery status, determine whether at least one first vehicle of the vehicles needs power based on the vehicle energy status of each vehicle, and in response to determining the first vehicle needs power, identify at least one second vehicle of the vehicles capable of donating power and facilitate a RF wireless transfer of power from the second vehicle to the first vehicle. Other example systems and methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for smart vehicle access for battery dead vehicles.

Vehicles often include digital access systems for providing access to the vehicles. For example, a digital access system for a vehicle may utilize a remote key fob, a digital key stored on a device (e.g., a smartphone), an application on a device, a fingerprint reader located in the vehicle, etc. to manage and control vehicle entry and access. For instance, a wireless reader, such as a near-field communication (NFC) reader, an ultra-wideband (UWB) reader, a Bluetooth (BLE) module, etc. located in the vehicle may be used in connection with the remote key fob, the digital key, the device application, etc. for managing and controlling vehicle entry and access. In such examples, components of the digital access systems located in the vehicle require electrical power for providing access to the vehicle. Such electrical power is provided by one or more batteries in the vehicle.

### SUMMARY

A system for facilitating energy harvesting of battery depleted vehicles, includes a plurality of vehicles each including a local control module, a radio frequency (RF) communication module, an energy harvesting module, and at least one battery module, and a system control module in communication with the local control module of each vehicle. The system control module is configured to acquire a vehicle energy status from the local control module of each vehicle, the vehicle energy status including a power donor status, a power conserving status, or a depleted battery status, determine whether at least one first vehicle of the plurality of vehicles needs power based on the acquired vehicle energy status of each vehicle, and in response to determining the first vehicle needs power, identify at least one second vehicle of the plurality of vehicles capable of donating power and facilitate a RF wireless transfer of power from the second vehicle to the first vehicle.

In other features, the system control module is configured to determine a location of each of the plurality of vehicles and select the second vehicle for the RF wireless transfer of power based on a distance between the first vehicle and the second vehicle.

In other features, the system control module is configured to acquire an updated vehicle energy status from the local control module of each vehicle after facilitating the RF wireless transfer of power from the second vehicle to the first vehicle and the updated vehicle energy status includes one of a power donor status, a power conserving status, or a depleted battery status.

In other features, the updated vehicle energy status of the second vehicle is a power conserving status, and the system control module is configured to, in response to the updated vehicle energy status of the second vehicle, identify a third vehicle of the plurality of vehicles capable of donating power based on the updated vehicle energy status of each vehicle and facilitate the RF wireless transfer of power from the third vehicle to the first vehicle.

In other features, the system control module is configured to determine an energy profile specific to each vehicle of the plurality of vehicles representing a minimum amount of power to maintain connectively for unlocking the vehicle and determine whether any of the plurality of vehicles needs power based on the acquired vehicle energy status of each vehicle and the energy profile specific to each vehicle.

In other features, the system control module is configured to transmit a signal to the second vehicle to facilitate the RF wireless transfer of power to the first vehicle.

In other features, the RF wireless transfer of power includes transmitting at least one of a Wi-Fi signal, a carrier signal in a band allowed for Wi-Fi signal transmission, or a Bluetooth wireless transfer of power.

In other features, the system control module is configured to receive signals from a set of the plurality of vehicles indicating an approval of donating power, and the set of the plurality of vehicles includes the second vehicle.

In other features, the local control module of the second vehicle is configured to monitor a power degradation of the battery module in the second vehicle, receive reports from a plurality of secondary control modules in the second vehicle each executing different functions for the second vehicle, the reports indicating a need for additional power beyond a set power usage budget, dynamically rank the secondary control modules based on the different functions for the second vehicle, and facilitate a transfer of power designated for one of the secondary control modules to another one of the secondary control modules based on the rank.

In other features, the local control module of the second vehicle is configured to, in response to the power degradation of the battery module in the second vehicle being less than a threshold, transmit an updated vehicle energy status to the system control module, and the updated vehicle energy status is a power conserving status.

In other features, the system control module is configured to, in response to the updated vehicle energy status of the second vehicle, identify a third vehicle of the plurality of vehicles capable of donating power in response to the updated vehicle energy status of the second vehicle and facilitate the RF wireless transfer of power from the third vehicle to the first vehicle.

A system for locally facilitating energy harvesting in a vehicle, includes a plurality of secondary control modules in the vehicle configured to execute different functions for the vehicle, each secondary control module having a set power usage budget, and a local master control module in communication with the secondary control modules. The local master control module is configured to monitor a power degradation of a battery module in the vehicle, receive a report from each secondary control module indicating a need for additional power beyond the set power usage budget, dynamically rank the secondary control modules based on the different functions for the vehicle, and facilitate a transfer of power designated for one of the secondary control modules to another one of the secondary control modules based on the rank.

In other features, the vehicle is a first vehicle participating in a radio frequency (RF) wireless transfer of power from the first vehicle to a second vehicle having a depleted battery module.

In other features, the local master control module is configured to, in response to the power degradation of the battery module being less than a threshold, transmit a vehicle energy status to a system control module facilitating energy harvesting between the first vehicle and the second vehicle.

In other features, the vehicle energy status is a power conserving status.

In other features, the secondary control modules are configured to execute the different functions for the vehicle when the vehicle is in a powered-off state.

A system for facilitating energy harvesting to access a vehicle, includes a vehicle having a door with a locking mechanism and a wireless communications receiver adjacent to the locking mechanism. The wireless communications receiver is configured to receive a radio frequency (RF) wireless transfer of power from a user device adjacent to the wireless communications receiver, and in response to receiving a threshold amount of power, transmit a signal to the locking mechanism to unlock the door.

In other features, the user device includes a wireless communications transmitter configured to facilitate the wireless transfer of power from the user device to the wireless communications receiver in the vehicle.

In other features, the wireless communications receiver is a near-field communication (NFC) reader.

In other features, the RF wireless transfer of power includes at least one of a Wi-Fi wireless transfer of power, an ultra-wideband (UWB) wireless transfer of power or a near-field communication (NFC) wireless of power.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example system for facilitating energy harvesting to battery depleted vehicles, according to the present disclosure;

FIG. 2 is an example vehicle that harvests energy from received wireless communication signals, according to the present disclosure;

FIG. 3 is a block diagram of another example system for facilitating energy harvesting to battery depleted vehicles, according to the present disclosure;

FIG. 4 is a block diagram of an example system employable by a vehicle for providing a vehicle energy status to a system control module, according to the present disclosure;

FIG. 5 is a block diagram of an example system for locally facilitating energy harvesting in a vehicle, according to the present disclosure;

FIG. 6 is a block diagram of an example system for facilitating energy harvesting to access a vehicle, according to the present disclosure;

FIG. 7 is a flow chart of an example control process for facilitating energy harvesting to battery depleted vehicles, according to the present disclosure; and

FIG. 8 is a flow chart of an example control process for locally facilitating energy harvesting in a vehicle, according to the present disclosure; and

FIG. 9 is a flow chart of an example control process for facilitating energy harvesting to access a vehicle, according to the present disclosure.

In the drawings, reference numbers may be reused to identify similar and/or identical elements.

### DETAILED DESCRIPTION

Vehicles often include digital access systems for providing access to the vehicles. Such digital access systems generally include components located in a vehicle (e.g., vehicle side components) to manage and control vehicle entry and access. Such vehicle side components (e.g., near-field communication (NFC) reader, an ultra-wideband (UWB) reader, a Bluetooth (BLE) module, a fingerprint reader, a keypad, etc.) require electrical power for providing access to the vehicle.

Such electrical power is provided by one or more batteries in the vehicle.

However, current implementations of digital access systems fail to account for scenarios where the vehicle has a completely dead battery. In a completely dead vehicle battery situation, power to all vehicle control modules or electronic control units (ECUs), including a digital access ECU is lost. Thus, in such scenarios, a vehicle with a dead battery would be unable to provide power to components (e.g., the NFC reader, etc.) of a digital access system to perform its intended function. As such, conventional digital key systems and/or fingerprint/keypad readers are rendered useless and inadequate to access a vehicle if the vehicle battery is dead.

Instead, when the vehicle battery is completely dead, vehicle access may be obtained through a physical key if available or by charging the vehicle battery if possible. This is undesirable as users may be denied entry to their vehicles for extended time periods.

The systems and methods according to the present disclosure leverage proximate vehicles to harvest energy to power up dead vehicle batteries using wireless energy harvesting techniques, such as UWB and Wi-Fi energy harvesting techniques. In various embodiments, the systems and methods may utilize one or more aspects for solving the problem associated with dead vehicle batteries. For example, the systems and methods may utilize a local control aspect and/or a central hub centric aspect. In the central hub centric aspect, vehicles may be connected to a system control module (e.g., an internet of things (IoT) hub, etc.). In such examples, the system control module may dynamically maintain a matrix and track vehicle status info and categorize and re-categorize vehicles that are master donors of energy harvest, as further explained below. In the local control aspect, each vehicle is equipped with a local master control module that can function as an IoT hub. In this example, the local master control module may keep track of an energy budget using degradation/performance of a power converter in the vehicle associated with key access control and/or vehicle batteries. With this approach, each secondary control module or ECU in the vehicle can send a dynamic or event-based report to the local master control module to allow the local master control module to maintain a rank of the secondary control modules for facilitating power transfer, as further explained below.

By employing the systems and methods herein for leveraging proximate vehicles to harvest energy, batteries in vehicles may be prevented from depleting and/or recharged. In turn, vehicle side components of digital access systems may be adequately powered, thereby ensuring vehicle access is maintained. As a result, users are permitted access to their vehicles, which enhances user experience. Additionally, in some examples, energy efficiency may be optimized by employing the systems and methods herein as further explained below.

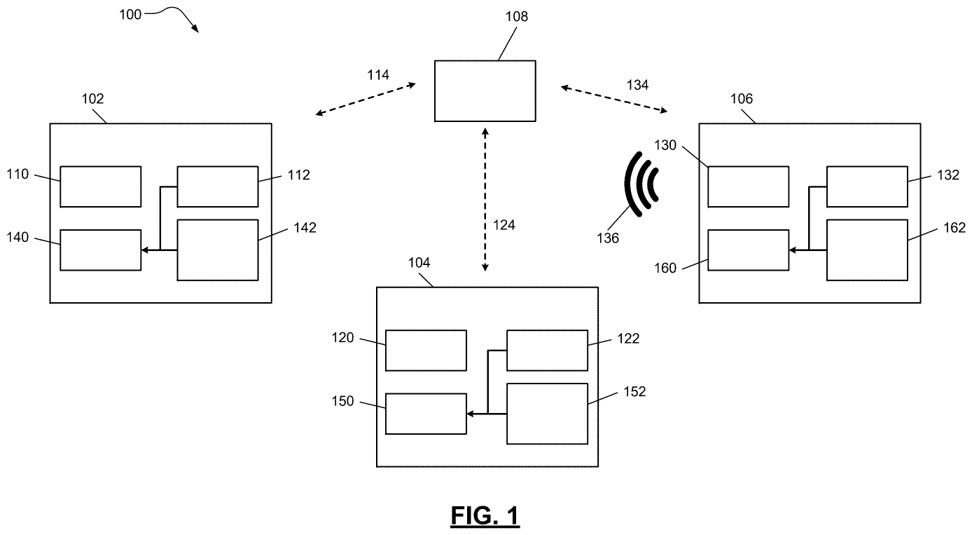

Referring now to FIG. 1, a block diagram of an example system 100 is presented for facilitating energy harvesting to battery depleted vehicles. As shown in FIG. 1, the system 100 generally includes multiple vehicles 102, 104, 106 and a system control module 108. In such examples, the system control module 108 may be an IoT hub at a vehicle dealership office or another suitable location for maintaining communication with the vehicles 102, 104, 106.

As shown in FIG. 1, each vehicle generally includes a local control module, at least one battery module, a radio frequency (RF) communication module, and an energy harvesting module (or circuit). In such examples, the RF communication module may be powered by the battery module and/or the energy harvesting module. For example, in FIG. 1, the vehicle 102 includes a local control module 110, a battery module 112, an RF communication module 140, and an energy harvesting module 142. The vehicle 104 includes a local control module 120, a battery module 122, an RF communication module 150, and an energy harvesting module 152. The vehicle 106 includes a local control module 130, a battery module 132, an RF communication module 160, and an energy harvesting module 162. Each battery module 112, 122, 132 may include one or more battery packs each having multiple battery cells capable of storing and supplying power.

While the system 100 is shown as including three vehicles 102, 104, 106, it should be appreciated that more or less vehicles may be employed if desired. For example, the system 100 may include two vehicles (e.g., one vehicle capable of donating power and one vehicle needing power), five vehicles, ten vehicles, twenty vehicles, fifty vehicles, etc.

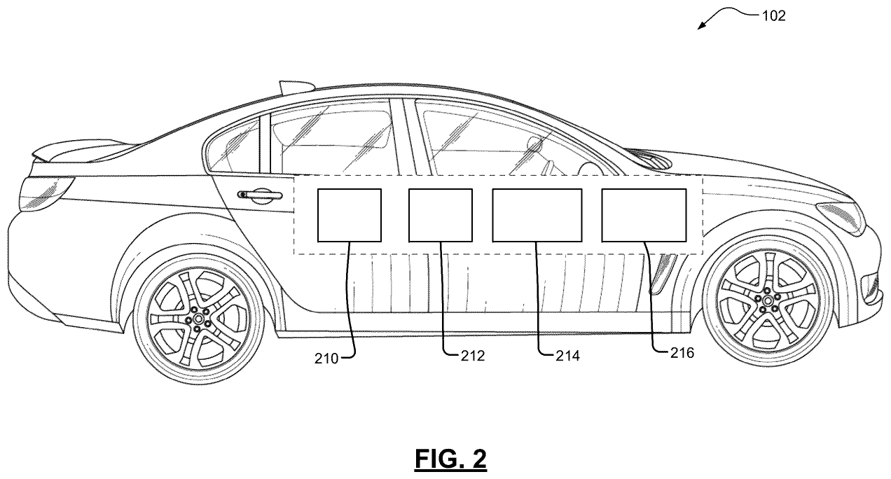

Each vehicle 102, 104, 106 may be any suitable type of vehicle, such as an electric vehicle (e.g., a pure electric vehicle, a plug-in hybrid electric vehicle, etc.), an internal combustion engine vehicle, etc. Additionally, each vehicle 102, 104, 106 may be an autonomous vehicle, a semi-autonomous vehicle, etc. For example, FIG. 2 depicts an example vehicle 200 including a local control module 210, a battery module 212, an RF communication module 214, and an energy harvesting circuit 216. Any one of the vehicles 102, 104, 106 of FIG. 1 may be represented by the vehicle 200.

With continued reference to FIG. 1, the system control module 108 is in communication the vehicles 102, 104, 106. More specifically, the system control module 108 is in communication with the local control modules 110, 120, 130 of the vehicles 102, 104, 106. In such examples, the system control module 108 may receive and/or transmit signals 114, 124, 134 between each of the local control modules 110, 120, 130, respectively. In various embodiments, the signals 114, 124, 134 may be transmitted and/or received by the system control module 108 other via a wireless network, such as a cellular network, a Wi-Fi network, etc.

In various embodiments, the system control module 108 acquires a vehicle energy status from the local control modules 110, 120, 130 of the vehicles 102, 104, 106. In such examples, the vehicle energy status may be provided with the signals 114, 124, 134. In some examples, each local control module 110, 120, 130 may determine its vehicle energy status (as further explained below) and then transmit or broadcast the respective signal 114, 124, 134 to the system control module 108. In other examples, the system control module 108 may transmit a request to each local control module 110, 120, 130 for a vehicle energy status of the respective vehicle 102, 104, 106.

In the example of FIG. 1, the vehicle energy status may include one of various different status or states. For example, the vehicle energy status for each vehicle 102, 104, 106 may be (i) a power donor status, (ii) a power conserving status, or (iii) a depleted battery status. In such examples, the power donor status indicates the capability to provide for a predetermined set of functions, e.g., to power vehicle control modules, such as an ECU for digital access control, and to send out a periodical and/or event-based battery energy status, and also donate some of its stored power. In other words, in this state, a particular vehicle may include a battery module having a remaining capacity sufficient (e.g., above a first threshold) to share with one or more other vehicles if needed, via RF signal transmission for a duration of time, e.g. via a Wi-Fi, Bluetooth, or BLE signal transmission. The power conserving status indicates the capability to provide for vehicle access but will not participate in donating energy to other vehicles due to low available power. As such, in this conserving state, a particular vehicle includes a battery module which may have enough remaining capacity (e.g., above a second threshold lower than the first threshold) to provide for a predetermined set of functions, including vehicle access, but the remaining capacity is conserved for the vehicle, rather than being partially used for donating energy to other vehicles. The depleted battery status indicates a battery module that is dead or otherwise depleted to level insufficient to power vehicle control modules, such as an ECU for digital access control. In FIG. 1, the vehicles 102, 104, 106 may have any one of the vehicle energy statuses explained above. For example, the vehicle 102 may have a depleted battery status, the vehicle 104 may have a power conserving status, and the vehicle 106 may have a power donor status.

In various embodiments, the system control module 108 may generate and maintain an energy harvest matrix. In such examples, the system control module 108 may dynamically maintain the energy harvest matrix by tracking the vehicle status information (e.g., received from the vehicles 102, 104, 106) and categorizing (and recategorizing when needed) particular vehicles based on their vehicle status information. For example, Table 1 below provides one example of an energy harvest matrix showing a correlation between a vehicle identification (ID) and an energy harvest status. In such examples, the system control module 108 may receive or otherwise obtain the vehicle ID and the energy harvest status from each vehicle 102, 104, 106. For example, in Table 1, the vehicle 102 has a vehicle ID of ZZZZ and a depleted battery status, the vehicle 104 has a vehicle ID of HHHH and a power conserving status, and the vehicle 106 has a vehicle ID of AAAA and a power donor status.

TABLE 1

| Vehicle ID | Energy Harvest Status |
|---|---|
| AAAA | Donor |
| HHHH | Conserving |
| ZZZZ | Depleted |

With continued reference to FIG. 1, the system control module 108 determines whether any of the vehicles 102, 104, 106 needs power based on the acquired vehicle energy status of each vehicle 102, 104, 106. In some examples, the system control module 108 may make this determination solely on the acquired vehicle energy statuses. For example, if an acquired vehicle energy status for a particular vehicle is a depleted battery status, the system control module 108 may identify that vehicle as needing power.

In other examples, the system control module 108 make this determination based on other information in addition to the acquired vehicle energy status. For example, in some embodiments, the system control module 108 may determine an energy profile specific to each vehicle 102, 104, 106 and then determine whether any of the vehicles 102, 104, 106 needs power based on the acquired vehicle energy status and the energy profile specific to each vehicle. In such examples, the energy profile represents a minimum amount of power required to maintain connectively for unlocking that specific vehicle 102, 104, 106. For example, one or more of the vehicles 102, 104, 106 may be a different vehicle make and/or model having different minimum power requirements. In various embodiments, the system control module 108 receive the energy profile from each vehicle 102, 104, 106 (e.g., along with the vehicle ID and the energy harvest status) and/or determine the energy profile from each vehicle 102, 104, 106 based on the vehicle ID. In this latter approach, the system control module 108 may include or access a database storing such information based on vehicle IDs.

Then, in response to determining at least one of the vehicles 102, 104, 106 needs power, the system control module 108 can identify at least one of the vehicles 102, 104, 106 capable of donating power and then facilitate an RF wireless transfer of power from the vehicle capable of donating power to the vehicle needing power. For example, and with continued reference to the example above, the system control module 108 may identify the vehicle 106 as being capable of donating power based on its power donor status and then facilitate an RF wireless transfer of power from the vehicle 106 to the vehicle 102 having a depleted battery status.

In the example of FIG. 1, the system control module 108 may facilitate the RF wireless transfer of power between vehicles in any suitable manner. For example, the system control module 108 may transmit a signal (e.g., the signal 134) to the vehicle 106 to facilitate the RF wireless transfer of power to the vehicle 102. Then, based on that signal, the RF communication module 160 in the vehicle 106 may broadcast a wireless communication 136 towards the vehicle 102, thereby enabling the vehicle 102 to harvest energy from the wireless communication. In such examples, the energy used for the RF signal transmission by the vehicle 106 with sufficient energy comes from its battery module 132 (not from the energy stored in its energy harvesting module 162 or circuitry).

The RF wireless transfer of power may be implemented with any suitable wireless communication protocol. For example, the RF wireless transfer of power may include at least one of a Wi-Fi wireless transfer of power (sometimes called power over Wi-Fi), Bluetooth, Bluetooth Low Energy (BLE), an ultra-wideband (UWB) wireless transfer of power, a near-field communication (NFC) wireless of power, or an unmodulated energizing waveform with the carrier frequency used to transmit a signal using one of the above technologies. For example, a waveform with the frequency within the 2.4 GHz ISM band, or within the unlicensed 5 GHz band may be transmitted for a predetermined duration of time, and at a transmit power within the transmit power range allowed for Wi-Fi signal transmissions. In such examples, wireless communication signals can be used to wirelessly transmit energy from one vehicle (e.g., the vehicle 106), which can be received by an energy harvesting circuit of another vehicle (e.g., the vehicle 102). The energy harvesting circuit can then harvest the energy from the wireless communication signals by, for example, converting the energy (e.g., electromagnetic energy) from the wireless communication signals to direct current (DC) power for charging a depleted battery module. As example only, the energy harvesting circuit many include a rectenna (or a rectifying antenna) having a suitable antenna (e.g., a dipole antenna, etc.) and one or more switching devices (e.g., one or more diodes, transistors, etc.) for rectifying the received energy.

In various embodiments, the vehicle capable of donating power may be determined based on a location of that vehicle and other vehicle needing power. For instance, the wireless communication signals providing the transfer of power may have a limited coverage range extending from the vehicle capable of donating power. In such examples, the range be decreased due to, for example, obstructions between the vehicles, the frequency band, etc. Additionally, in some examples, the strength of the wireless communication signals may degrade as a function of distance. As such, the RF wireless transfer of power may be or become inefficient as the distance between the vehicles increase.

Thus, in some embodiments the system control module 108 may determine a location of each vehicle 102, 104, 106 and then select the vehicle (e.g., the vehicle 106) for the RF wireless transfer of power based on a distance between the vehicle capable of donating power and the vehicle needing power. In such examples, the system control module 108 may determine the locations of the vehicles 102, 104, 106 in any suitable manner. For instance, each vehicle 102, 104, 106 may provide its location to the system control module 108. In other examples, one or more of the vehicles 102, 104, 106 may determine locations of other vehicles based on characteristics of communication signals (e.g., signal strength, time of arrival, angle of arrival, etc.) received from those vehicles, and then provide the locations to the system control module 108.

In another embodiment, a vehicle may act as proxy for one or more vehicles within its close proximity range, and send, in addition to its own vehicle energy status, the vehicle energy status of the one or more vehicles to the system control module 108. For example, the vehicle acting as proxy may be closer than a threshold to the vehicle it serves, such that the communication between the served vehicle and the proxy vehicle takes less energy than the communication between the served vehicle and the system control module 108. Accordingly, the proxy vehicle receives energy status updates from the vehicles it serves, and sends those updates together with its own updates to the system control module 108.

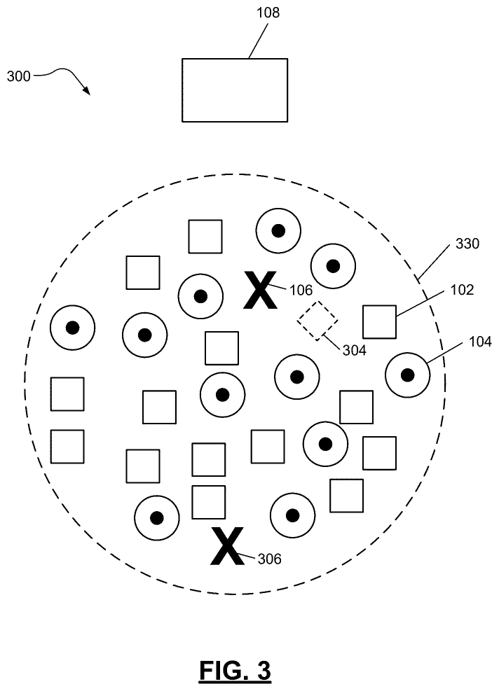

For example, FIG. 3 depicts an example system 300 with the system control module 108 of FIG. 1 along with multiple vehicles including the vehicles 102, 104, 106 of FIG. 1. In this example, the system control module 108 acquires a vehicle energy status from vehicles, including the vehicles 102, 104, 106 within a defined area 330. Specifically, in FIG. 3, each vehicle having a power donor status are represented by an X, each vehicle having a power conserving status are represented by a circle with a dot, and each vehicle having a depleted battery status are represented by a square. In the example of FIG. 3, the vehicle 106 is selected as the vehicle for donating power to the vehicle 102 due to the proximity between the vehicles 102, 106. More specifically, in FIG. 3, the system control module 108 selects the vehicle 106 over other vehicles (e.g., a vehicle 306) based on the distance between the vehicles 102, 106 as compared to the distance between the vehicles 102, 306.

In some examples, the vehicles in the defined area 330 may be required to agree or approve of RF wireless transfer of power. For example, the system control module 108 may receive signals from a set of vehicles indicating an approval of donating power. In the example of FIG. 3, the system control module 108 may receive signals from the vehicles 106, 306. In such examples, approval of receiving RF wireless transfer of power may be not required. In other words, not all vehicles in the defined area 330 are active participants in the RF wireless transfer of power. With this arrangement, one or more vehicles not actively participating may benefit from the wireless communication signals if the vehicles have suitable energy harvesting circuitry.

For example, in FIG. 3, a vehicle 304 is shown as being located in the defined area 330 and between the vehicles 102, 106. As such, the vehicle 304 is positioned in the coverage range of wireless communication signals between the vehicles 102, 106. In this example, the vehicle 304 did not provide its vehicle energy status to the system control module 108 and therefore is not actively participating in the RF wireless transfer of power. However, when the vehicle 106 transmits wireless communication signals towards the vehicle 102 (needing power), the vehicle 304 may harvest energy from the wireless communication signals in a similar manner as the vehicle 102.

Additionally, in various embodiments, the system control module 108 of FIGS. 1 and 3 may group vehicle selection and pairing based on common architecture or application needs to leverage RF energy harvest intelligently. For example, in FIG. 3, some or all of the vehicles within the defined area 330 may be identified by the system control module 108 as a group/fleet environment in which the grouped vehicles have similar vehicle types (e.g., similar makes and/or models), similar energy profiles, similar digital access systems, etc. With this approach, the system control module 108 may identify on a single or multiple energy efficient vehicles in the group/fleet environment for power donation. In turn, energy harvesting may be optimized based on situational awareness such as transmission rates, select technologies, vehicle types, etc.

With continued reference to FIG. 1, the system control module 108 may acquire updated vehicle energy statuses after facilitating the RF wireless transfer of power between vehicles. For example, after the vehicle 106 provides wireless communication signals for energy harvesting, a power degradation of the battery module 132 in the vehicle 106 may decrease below a threshold. In such examples, the vehicle 106 may provide an updated vehicle energy status (e.g., one of a power donor status, a power conserving status, or a depleted battery status). Specifically, in this example, the updated vehicle energy status of the vehicle 106 may be a power conserving status.

Then, in response to the updated vehicle energy statuses, the system control module 108 may take various steps. For example, the system control module 108 may update (e.g., dynamically maintain) an energy harvest matrix, such as the energy harvest matrix in Table 1 above. Additionally, in response to the updated vehicle energy statuses, the system control module 108 may identify a new vehicle (e.g., the vehicle 102, the vehicle 104, or another suitable vehicle) capable of donating power based on the updated vehicle energy status of each vehicle. Then, the system control module 108 can facilitate the RF wireless transfer of power from that new vehicle as explained above.

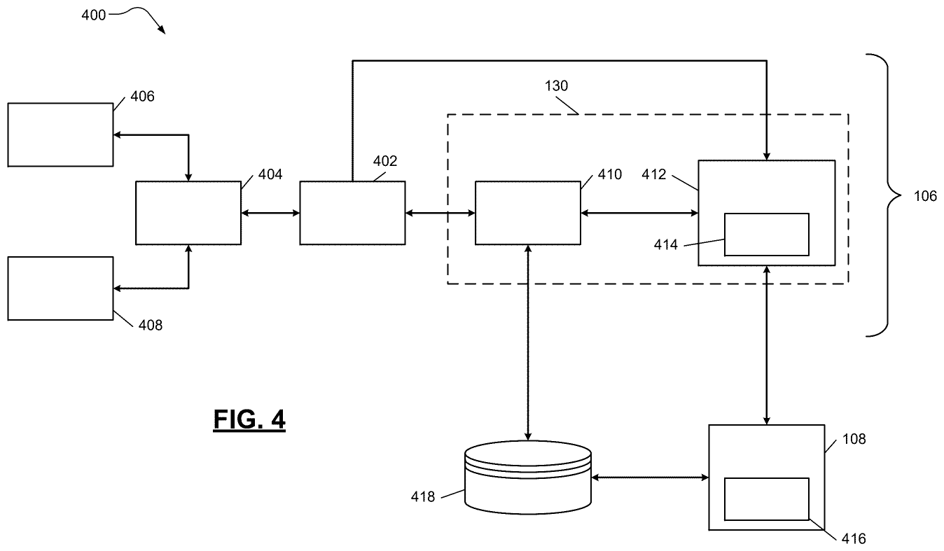

In the examples herein, the vehicle energy status and updates thereof for each vehicle may be determined locally. For example, FIG. 4 depicts a system 400 including the system control module 108 and the vehicle 106 of FIG. 1, in which the vehicle 106 determines its vehicle energy status and updates thereof and transmits the status and updates to the system control module 108.

For example, in FIG. 4, the vehicle 106 includes the local control module 130 of FIG. 1, an energy harvesting circuit 402, a power converter 404, a high voltage battery 406, and a low voltage battery 408. In this example, the high voltage battery 406 and/or the low voltage battery 408 may be a part of a battery module, such as the battery module 132 of FIG. 1. The energy harvesting circuit 402 may include suitable components (e.g., an antenna, and one or more switching devices, etc.) as explained above. Additionally, and as show in FIG. 4, the local control module 130 includes a central gateway module (CGM) 410 and an RF communication module 412 having a wireless communication protocol 414. In various embodiments, and as further explained below, the wireless communication module (e.g., an RF communication module) 412 may use energy of the battery 408 to send status messages to the system control module 108 while the vehicle battery is not low.

In the example of FIG. 4, the local control module 130 may monitor remaining capacities of the high voltage battery 406 and the low voltage battery 408, and then determine its vehicle energy status and/or updates thereof based on the remaining capacities. Then, after the vehicle energy status and/or updates are determined, the communication module 412 of the local control module 130 may transmit a signal (e.g., the signal 134) to the system control module 108 having a wireless communication protocol 416. In various embodiments, the wireless communication protocols 414, 416 may be any suitable messaging protocol, such as a message queuing telemetry transport (MQTT) protocol.

In this example, the signal may indicate a power donor status for the vehicle 106. In response, the system control module 108 may store or update the vehicle energy status in an energy harvest matrix located in a database 418 to specify the vehicle 106 as being capable of donating power (or having a power donor status). Then, the CGM 410 may subsequently receive an energy harvest request from the database 418 or the system control module 108 indicating a desire for the vehicle 106 to provide wireless communication signals to enable RF wireless transfer of power from the vehicle 106 to another vehicle (e.g., the vehicle 102 of FIG. 1).

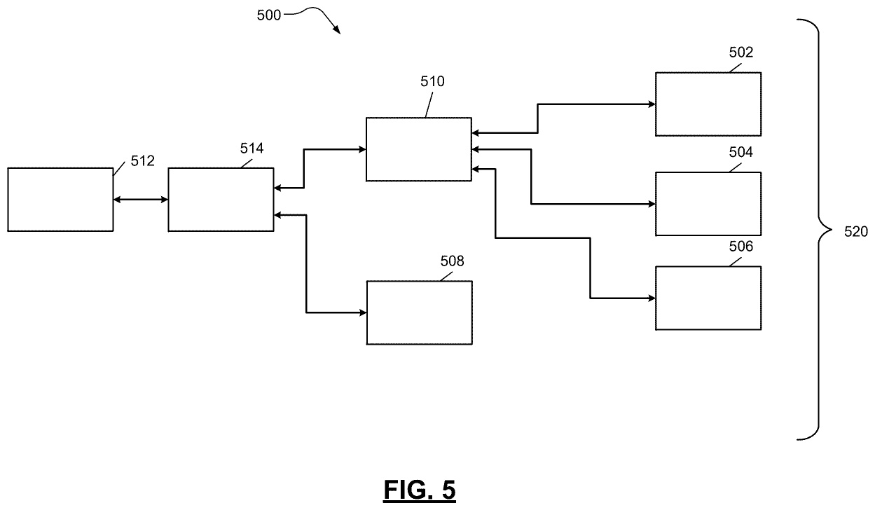

In various embodiments, the examples herein may utilize a local control aspect in which a local master control module in a particular vehicle may track an energy budget using degradation/performance of a power converter in that vehicle associated with key access control and/or vehicle batteries. For example, FIG. 5 depicts a system 500 for locally facilitating energy harvesting in a vehicle 520. In this example, the vehicle 520 may be equivalent to any one of the vehicles 102, 104, 106 of FIG. 1.

As shown in FIG. 5, the system 500 generally includes multiple secondary control modules 502, 504, 506 and a local master control module 510 in communication with the secondary control modules 502, 504, 506. The secondary control modules 502, 504, 506 and the local master control module 510 are located in the vehicle 520. In some examples, the local master control module 510 may be equivalent to any one of the local control modules 110, 120, 130 in FIG. 1. While the system 500 is shown as including three secondary control modules 502, 504, 506, it should be appreciated that more or less secondary control modules may be employed if desired.

In the example of FIG. 5, the secondary control modules 502, 504, 506 are configured (e.g., programmed, etc.) to execute different functions for the vehicle 520. In such examples, at least some of the functions executed by the secondary control modules 502, 504, 506 may be performed while the vehicle 520 is in an off state (e.g., powered off). For example, the secondary control module 502 may be a digital access ECU for controlling and powering a component (e.g., an NFC reader, etc.) for accessing the vehicle 520, and the secondary control modules 504, 506 may be utilized for other vehicle control features. To implement such functions, the secondary control modules 502, 504, 506 require power. In FIG. 5, the secondary control modules 502, 504, 506 may receive power from a battery module 512 via a power converter 514 in the vehicle 520.

In such examples, each secondary control module 502, 504, 506 has a set power usage budget for executing while the vehicle 520 is in an off state. For example, due to the limited amount of power stored in the battery module 512 while the vehicle 520 is in an off state, each secondary control module 502, 504, 506 may have a set amount of power it can use for a given period. This ensures one of the secondary control modules 502, 504, 506 does not monopolize the available power stored in the battery module 512.

In FIG. 5, the local master control module 510 receives a report from one or more of the secondary control modules 502, 504, 506 indicating a need for additional power beyond its set power usage budget. For example, the report from one secondary control module may indicate a need to continue powering a component for accessing the vehicle 520 and the report from another secondary control module may indicate a need to update firmware in the secondary control module while the vehicle 520 is in an off state.

Then, the local master control module 510 dynamically ranks the secondary control modules 502, 504, 506 based on the different functions for the vehicle 520. For example, the secondary control module 502 that controls power to a component for accessing the vehicle 520 may rank higher (e.g., have a higher priority) than the secondary control module 504 that updates vehicle parameters while the vehicle 520 is in an off state.

The local master control module 510 may then facilitate a transfer of power designated for one of the secondary control modules 502, 504, 506 to another one of the secondary control modules 502, 504, 506 based on the rank. For instance, when the secondary control module 502 indicates a need for additional power beyond its set power usage budget, the local master control module 510 may transfer power initially designated for the secondary control module 504 to the secondary control module 502. This is because the secondary control module 502 has a higher rank (e.g., a higher priority) than the secondary control module 504.

Additionally, the local master control module 510 may monitor a power degradation of the battery module 512 in the vehicle 520. This may be accomplished through one or more sensors measuring electrical characteristics (e.g., voltage, current, etc.) of the battery module 512 and known battery characteristics. For example, due to the transfer of power explained above, the power degradation of the battery module 512 may be less than a threshold (e.g., a remaining capacity value). In response, the local master control module 510 may transmit a vehicle energy status or an update thereof to a system control module, such as the system control module 108 of FIG. 1 that facilitates energy harvesting between vehicles.

For instance, the vehicle 520 may be participating in an RF wireless transfer of power to another vehicle having a depleted battery module. In such examples, if the power degradation of the battery module 512 falls below the threshold, the local master control module 510 may update its vehicle energy status from a power donor status to a power conserving status.

In other examples, the vehicle energy status (or the updated status) for the vehicle 520 may be a depleted battery status. In this scenario, the system control module may facilitate an RF wireless transfer of power from another vehicle to the vehicle 520, as explained above. In such examples, an energy harvesting circuit 508 in the vehicle 520 receives wireless communication signals from the other vehicle, and then harvests energy from the wireless communication signals by, for example, converting the energy (e.g., electromagnetic energy) from the wireless communication signals to DC power for charging the depleted battery module 512.

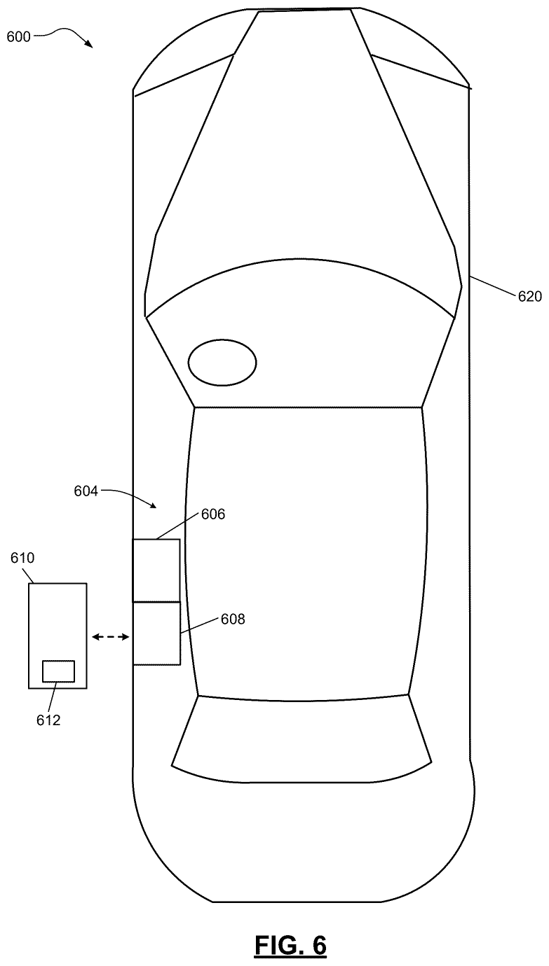

In various embodiments, energy harvesting may take place between a user device and a vehicle to enable vehicle access. For example, FIG. 6 depicts a system 600 for facilitating energy harvesting to access a vehicle 620. In this example, the vehicle 620 may be equivalent to any one of the vehicles 102, 104, 106 of FIG. 1.

As shown in FIG. 6, the system 600 generally includes the vehicle 602 having a door 604 with a locking mechanism 606 and a wireless communications receiver 608 adjacent to the locking mechanism 606. In this example, the wireless communications receiver 608 may be an NFC reader and/or any other suitable wireless receiver. Additionally, the locking mechanism 606 may be any suitable mechanical device that can be actuated to lock or unlock the door 604 based on signals from the wireless communications receiver 608.

In this example, the wireless communications receiver 608 receives an RF wireless transfer of power from a user device 610 adjacent to the wireless communications receiver 608. Then, in response to receiving a threshold amount of power through the RF wireless transfer of power, the wireless communications receiver 608 transmits a signal to the locking mechanism 606 to unlock the door 604. In such examples, the wireless communications receiver 608 may include or be coupled to an energy harvesting circuit (not shown) in the vehicle 620, which is capable of harvesting energy from wireless communication signals provided by a wireless transmitter 612 in the user device 610 as explained above. In such examples, the RF wireless transfer of power may be a Wi-Fi wireless transfer of power, an UWB wireless transfer of power or an NFC wireless of power.

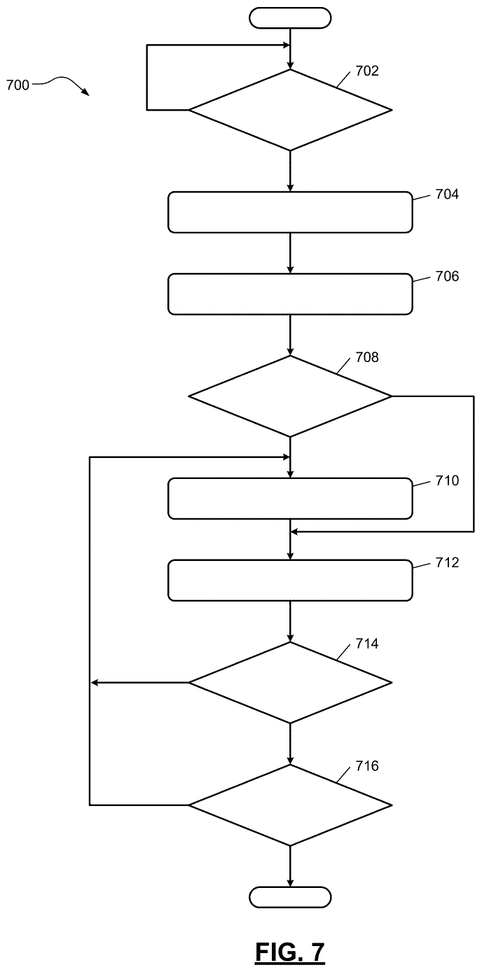

FIGS. 7-9 illustrate example control processes 700, 800, 900 for facilitating energy harvesting. For example, the control process 700 may be implemented by the system 100 of FIG. 1 for facilitating energy harvesting to battery depleted vehicles, the control process 800 may be implemented by the system 500 of FIG. 5 for locally facilitating energy harvesting in a vehicle, and the control process 900 may be implemented by the system 600 of FIG. 6 for facilitating energy harvesting to access a vehicle. Although the example control processes 700, 800, 900 are described below in relation to the systems 100, 500, 600, any one of the control processes 700, 800, 900 may be employable by another suitable system.

As shown in FIG. 7, the control process 700 begins at 702 by determining whether a group of vehicles (e.g., the vehicles 102, 104, 106 of FIG. 1) are in a common location and active for participating in RF wireless transfer of power. If no, the control process 700 returns to 702. Otherwise, if yes at 702, the control process 700 proceeds to 704.

At 704, the system control module 108 acquires a vehicle energy status from the local control modules 110, 120, 130 of the vehicles 102, 104, 106, as explained above. Then, the control process 700 proceeds to 706, where the system control module 108 sets of an energy profile specific to each vehicle 102, 104, 106. For example, and as explained above, the system control module 108 may determine an energy profile specific to each vehicle 102, 104, 106 based on the vehicle make and/or model having different minimum power requirements. The control process 700 then proceeds to 708.

At 708, the system control module 108 determines whether any of the vehicles 102, 104, 106 are in need of power. For example, and as explained above, the system control module 108 determine the vehicle 106 needs power based on the acquired vehicle energy status of that vehicle and/or the energy profile specific to the vehicle 106. If yes at 708, the control process 700 proceeds to 710. Otherwise, if no at 708, the control process 700 proceeds to 712.

At 710, the system control module 108 identifies at least one of the vehicles 102, 104, 106 capable of donating power and then facilitates an RF wireless transfer of power from the donating vehicle to the vehicle in need of power, as explained above. For example, the RF communication module in the donating vehicle (e.g., the vehicle 106) may broadcast an RF communication towards the vehicle in need (e.g., the vehicle 102), thereby enabling the vehicle 102 to harvest energy from the wireless communication. In such examples, the energy used for the RF signal transmission by the donating vehicle with sufficient energy comes from its battery module (not from the energy stored in its energy harvesting module or circuitry). Then, the control process 700 proceeds to 712, where the system control module 108 acquires updated vehicle energy statuses from one or more of the vehicles 102, 104, 106, as explained above. The control process 700 then proceeds to 714.

At 714, the system control module 108 determines whether any change in the status has occurred from the power donating vehicle. For example, and as explained above, the power donating vehicle may update its vehicle energy status from a power donor status to a power conserving status. If yes at 714, the control process 700 returns to 710 where the system control module 108 identifies another vehicle capable of donating power and then facilitates an RF wireless transfer of power from that donating vehicle to the vehicle in need of power, as explained above. If no at 714, the control process 700 proceeds to 716.

At 716, the system control module 108 again determines whether any of the vehicles 102, 104, 106 need power. In some examples, the system control module 108 may confirm the vehicle 106 still needs power or that another vehicle needs power. If yes at 716, the control process 700 returns to 710. Otherwise, if no at 716, the control process 700 may end.

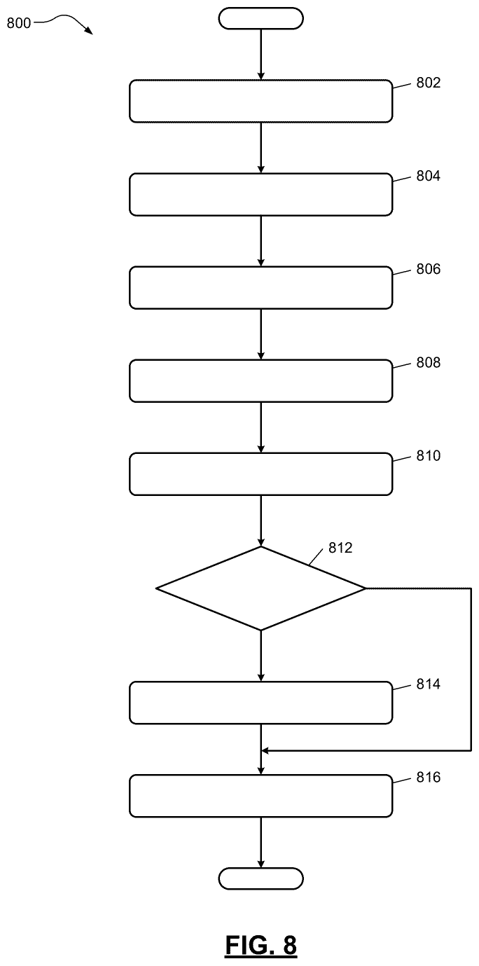

In FIG. 8, the control process 800 begins at 802 by transmitting a vehicle energy status to a system control module, such as the system control module 108 of FIG. 1. For example, and as explained above, the local master control module 510 may determine and provide a power donor status, a power conserving status, or a depleted battery status to the system control module. The control process 800 then proceeds to 804, where the local master control module 510 monitors power degradation in the vehicle 520. For instance, and as explained above, while the vehicle 520 is in an off state (e.g., powered off), the battery module 512 may continue to provide power to one or more control modules in the vehicle 520, such as the secondary control modules 502, 504, 506. This eventually may degrade a power level (e.g., a remaining capacity) of the battery module 512. Then, the control process 800 proceeds to 806.

At 806, the local master control module 510 receives a report from one or more of the secondary control modules 502, 504, 506 indicating a need for additional power beyond its set power usage budget. In such examples, the report from the secondary control module 502 may indicate a need to continue powering a component for accessing the vehicle 520, the report from the secondary control module 504 may indicate a need to update firmware while the vehicle 520 is in an off state, and the report from the secondary control module 506 may indicate a need to update vehicle parameters while the vehicle 520 is in an off state. Then, at 808, the local master control module 510 generates a local harvest matrix for the vehicle 520. For example, the local master control module 510 create and store the local harvest matrix with identifiers for each secondary control module 502, 504, 506 and its corresponding set power usage budget.

The control process 800 then proceeds to 810, where the local master control module 510 dynamically ranks the secondary control modules 502, 504, 506 in the vehicle. In such examples, the local master control module 510 can rank in real time (and updated if needed) the secondary control modules 502, 504, 506 according to their different functions executed for the vehicle 520. For example, the secondary control module 502 that controls power to a component for accessing the vehicle 520 may rank higher than the secondary control module 506 that may update vehicle parameters while the vehicle 520 is in an off state. Then, at 812, the local master control module 510 determines if any of the secondary control module 502, 504, 506 in need of power (e.g., additional power beyond its set power usage budget). If no, the control process 800 proceeds to 816. If yes, the control process 800 proceeds to 814.

At 814, the local master control module 510 facilitates a transfer of power designated for one of the secondary control modules 502, 504, 506 to another one of the secondary control modules 502, 504, 506 in need. In such examples, the transfer of power is determined based on the ranking for the secondary control modules 502, 504, 506. For example, the secondary control module 502 may have a higher rank than the secondary control module 504. In such scenarios, when the secondary control module 502 indicates a need for additional power beyond its set power usage budget, the local master control module 510 may transfer power initially designated for the secondary control module 504 to the secondary control module 502. The control process 800 proceeds to 816, where the local master control module 510 transmits an updated vehicle energy status to the system control module. For example, and as explained above, the local master control module 510 may determine a change in its status (e.g., from a power donor status to a power conserving status), and then provide the updated vehicle energy status to the system control module. The control process 800 may end as shown in FIG. 8 or return to another suitable step if desired.

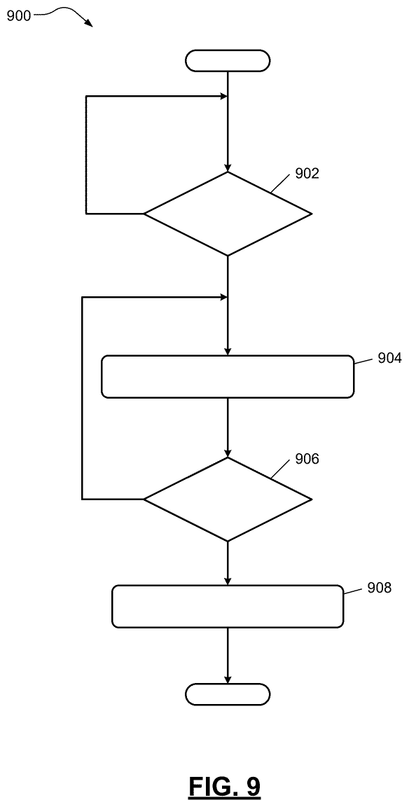

In FIG. 9, the control process 900 begins with a battery state of the vehicle 620 as being dead or depleted. In other words, in this example, a battery module in the vehicle 620 is unable to provide sufficient power to, for example, a control module such as a digital access ECU for controlling the locking mechanism 606 of FIG. 6 to unlock the door 604. In such examples, the control module may receive power from a user device near the wireless communications receiver 608 of the vehicle 620. In such examples, the control module may a part of or in communication with the wireless communications receiver 608. As such, at 902, if a user device is in proximity to the wireless communications receiver 608 (yes at 902), the control process 900 proceeds to 904. Otherwise, if a user device is not in proximity to the wireless communications receiver 608 (no at 902), the control process 900 returns to 902.

At 904, the control module facilitates an RF wireless transfer of power from the user device in proximity to the wireless communications receiver 608. In such examples, the wireless communications receiver 608 may include or be coupled to an energy harvesting circuit in the vehicle 620, which is capable of harvesting energy from wireless communication signals provided by a wireless transmitter in the user device as explained above. In such examples, the RF wireless transfer of power may be a Wi-Fi wireless transfer of power, an UWB wireless transfer of power or an NFC wireless of power. The control process 900 then proceeds to 906.

At 906, the control module determines whether the power received from the user device (e.g., harvested from wireless communication signals from the user device) is greater than a threshold. For example, if a sufficient amount of power is harvested from the wireless communication signals, the control module (e.g., a digital access ECU) can control the locking mechanism 606 to unlock the door 604. If no at 906, the control process 900 returns to 904. If yes at 906, the control module controls the locking mechanism 606 to unlock the door 604 at 908. The control process 900 then ends as shown in FIG. 9.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for facilitating energy harvesting of battery depleted vehicles, the system comprising:
a plurality of vehicles each including a local control module, a radio frequency (RF) communication module, an energy harvesting module, and at least one battery module; and
a system control module in communication with the local control module of each vehicle, the system control module configured to:
acquire a vehicle energy status from the local control module of each vehicle, the vehicle energy status including a power donor status, a power conserving status, or a depleted battery status;
determine whether at least one first vehicle of the plurality of vehicles needs power based on the acquired vehicle energy status of each vehicle; and
in response to determining the first vehicle needs power, identify at least one second vehicle of the plurality of vehicles capable of donating power and facilitate a RF wireless transfer of power from the second vehicle to the first vehicle.

2. The system of claim 1, wherein the system control module is configured to:
determine a location of each of the plurality of vehicles; and
select the second vehicle for the RF wireless transfer of power based on a distance between the first vehicle and the second vehicle.

3. The system of claim 2, wherein:
the system control module is configured to acquire an updated vehicle energy status from the local control module of each vehicle after facilitating the RF wireless transfer of power from the second vehicle to the first vehicle; and
the updated vehicle energy status includes one of a power donor status, a power conserving status, or a depleted battery status.

4. The system of claim 3, wherein:
the updated vehicle energy status of the second vehicle is a power conserving status; and
the system control module is configured to, in response to the updated vehicle energy status of the second vehicle, identify a third vehicle of the plurality of vehicles capable of donating power based on the updated vehicle energy status of each vehicle and facilitate the RF wireless transfer of power from the third vehicle to the first vehicle.

5. The system of claim 2, wherein the system control module is configured to:
determine an energy profile specific to each vehicle of the plurality of vehicles representing a minimum amount of power to maintain connectively for unlocking the vehicle; and
determine whether any of the plurality of vehicles needs power based on the acquired vehicle energy status of each vehicle and the energy profile specific to each vehicle.

6. The system of claim 2, wherein the system control module is configured to transmit a signal to the second vehicle to facilitate the RF wireless transfer of power to the first vehicle.

7. The system of claim 6, wherein the RF wireless transfer of power includes transmitting at least one of a Wi-Fi signal, a carrier signal in a band allowed for Wi-Fi signal transmission, or a Bluetooth wireless transfer of power.

8. The system of claim 1, wherein:
the system control module is configured to receive signals from a set of the plurality of vehicles indicating an approval of donating power; and
the set of the plurality of vehicles includes the second vehicle.

9. The system of claim 1, wherein the local control module of the second vehicle is configured to:
monitor a power degradation of the battery module in the second vehicle;
receive reports from a plurality of secondary control modules in the second vehicle each executing different functions for the second vehicle, the reports indicating a need for additional power beyond a set power usage budget;
dynamically rank the secondary control modules based on the different functions for the second vehicle; and
facilitate a transfer of power designated for one of the secondary control modules to another one of the secondary control modules based on the rank.

10. The system of claim 9, wherein:
the local control module of the second vehicle is configured to, in response to the power degradation of the battery module in the second vehicle being less than a threshold, transmit an updated vehicle energy status to the system control module; and
the updated vehicle energy status is a power conserving status.

11. The system of claim 10, wherein the system control module is configured to, in response to the updated vehicle energy status of the second vehicle, identify a third vehicle of the plurality of vehicles capable of donating power in response to the updated vehicle energy status of the second vehicle and facilitate the RF wireless transfer of power from the third vehicle to the first vehicle.

12. A system for locally facilitating energy harvesting in a vehicle, the system comprising:
a plurality of secondary control modules in the vehicle configured to execute different functions for the vehicle, each secondary control module having a set power usage budget; and
a local master control module in communication with the secondary control modules, the local master control module configured to:
monitor a power degradation of a battery module in the vehicle;
receive a report from each secondary control module indicating a need for additional power beyond the set power usage budget;
dynamically rank the secondary control modules based on the different functions for the vehicle; and
facilitate a transfer of power designated for one of the secondary control modules to another one of the secondary control modules based on the rank.

13. The system of claim 12, wherein the vehicle is a first vehicle participating in a radio frequency (RF) wireless transfer of power from the first vehicle to a second vehicle having a depleted battery module.

14. The system of claim 13, wherein the local master control module is configured to, in response to the power degradation of the battery module being less than a threshold, transmit a vehicle energy status to a system control module facilitating energy harvesting between the first vehicle and the second vehicle.

15. The system of claim 14, wherein the vehicle energy status is a power conserving status.

16. The system of claim 12, wherein the secondary control modules are configured to execute the different functions for the vehicle when the vehicle is in a powered-off state.

17. A system for facilitating energy harvesting to access a vehicle, the system comprising:
a vehicle including a door having a locking mechanism and a wireless communications receiver adjacent to the locking mechanism, the wireless communications receiver configured to receive a radio frequency (RF) wireless transfer of power from a user device adjacent to the wireless communications receiver, and in response to receiving a threshold amount of power, transmit a signal to the locking mechanism to unlock the door.

18. The system of claim 17, further comprising the user device including a wireless communications transmitter configured to facilitate the wireless transfer of power from the user device to the wireless communications receiver in the vehicle.

19. The system of claim 17, wherein the wireless communications receiver is a near-field communication (NFC) reader.

20. The system of claim 17, wherein the RF wireless transfer of power includes at least one of a Wi-Fi wireless transfer of power, an ultra-wideband (UWB) wireless transfer of power or a near-field communication (NFC) wireless of power.
